(19) United States
(12) Patent Application Publication
(10) Pub. No.: US 2026/0073746 A1
(43) Pub. Date: Mar. 12, 2026

(54) KEY MANAGEMENT SYSTEM

(71) Applicant: DQS Solutions & Staffing, Dearborn, MI (US)

(72) Inventor: Joshua Morris, Newport, MI (US)

(73) Assignee: DQS Solutions & Staffing, Dearborn, MI (US)

(21) Appl. No.: 19/322,012

(22) Filed: Sep. 8, 2025

Related U.S. Application Data
(60) Provisional application No. 63/694,043, filed on Sep. 12, 2024.

(51) Int. Cl. G07C 9/00; G06V 20/52; G07C 9/32

(52) U.S. Cl. CPC G07C 9/00896; G06V 20/52; G07C 9/32; G07C 2009/00936

(57) ABSTRACT

A key management system includes an organizational container, a processing circuit, and a camera system. The organizational container includes individualized compartments for organizing keys. The processing circuit includes one or more processors configured to record personnel information of a first entity and a second entity involved in a key exchange transaction, receive a key corresponding to a vehicle parked by the first entity, scan a vehicle identification number (VIN) of a vehicle corresponding to the key exchange transaction as first transaction information, receive information relating to a compartment of the organizational container to which vehicle keys corresponding to the vehicle are assigned as second transaction information, display information relating to the key exchange transaction to the second entity via a display device, and store the first transaction information and the second transaction information in one or more data structures as transaction information.

### CROSS-REFERENCE TO RELATED PATENT APPLICATION

The application claims priority to and the benefit of U.S. Provisional Ser. No. 63/694,043, filed Sep. 12, 2024, the disclosure of which is incorporated herein by reference in its entireties for all purposes.

### BACKGROUND

Automotive dealerships, vehicle storage spaces, and other vehicle holding sites for manufactured vehicles are often susceptible to opportunity theft. Opportunity vehicle theft refers to the act of stealing a vehicle when an opportunity presents itself, typically when security is insufficient and/or unauthorized access to the keys of the vehicle is available. However, conventional key management systems do not provide means for maintaining a level of secrecy of information between entities involved in storing vehicles. These gaps in security oftentimes do not hold involved entities accountable for opportunity theft, which may cause stress points for car manufacturers. Accordingly, it would be advantageous to provide a key management system to simultaneously collect information of personnel involved in key storage transactions while maintaining a level of secrecy of information between both entities to prevent improper access to keys and the opportunity for vehicle theft.

### SUMMARY

One embodiment of the present disclosure relates to a key management system. The key management system may include an organizational container comprising in individualized compartments for organizing keys. The key management system may include a processing circuit comprising one or more processors configured to record personnel information of entities involved in a key exchange transaction. The entities may include a first entity and a second entity. The processing circuit may be configured to receive a key corresponding to a vehicle parked by the first entity. The processing circuit may be configured to scan a vehicle identification number (VIN) of a vehicle corresponding to the key exchange transaction, the VIN comprising first transaction information. The processing circuit may be configured to assign vehicle keys corresponding to the vehicle, to a designated compartment of the storage location, the designated compartment to which the vehicle keys are assigned comprising second transaction information. The processing circuit may be configured to display, via a display device, information relating to the designated compartment to the second entity. The processing circuit may be configured to store, in a database, as transaction information, the first transaction information, and the second transaction information. The key management system may include a camera system record video footage of the key exchange transaction between involved parties. The camera system may be configured to store the recorded video footage to the database in association with the transaction information.

Another embodiment of the present disclosure relates to a method of storing vehicle keys using a key management system. The method may include recording personnel information of entities involved in a key exchange transaction. The method may include recording a key corresponding to a vehicle belonging to a first entity. The method may include scanning a vehicle identification number (VIN) of a vehicle corresponding to the key exchange transaction comprising first transaction information. The method may include assigning vehicle keys corresponding to the vehicle to a designated compartment of the organizational container via a processing circuit. The location of the designated compartment to which the vehicle keys are assigned may comprise second transaction information. The method may include displaying, via a display device, information relating to the designated compartment to a second entity. The method may include storing, in a database, as a transaction information, the first transaction information, and the second transaction information. The method may include placing the vehicle keys in the designated compartment of an organizational container.

Another embodiment of the present disclosure relates to a method of removing vehicle keys from storage using a key management system. The method may include recording personnel information of entities involved in a key exchange transaction. The method may include recording a key corresponding to a vehicle belonging to a first entity. The method may include scanning a vehicle identification number (VIN) of a vehicle corresponding to the key exchange transaction. The VIN may comprise first transaction information. The method may include locating vehicle keys corresponding to the vehicle in a designated compartment of the organizational container. The location of the designated compartment to which the vehicle keys are assigned may comprise second transaction information. The method may include displaying, via a display device, information relating to the designated compartment to a second entity. The method may include notifying the second party to remove the vehicle keys from the stored compartment of the organizational container and deliver the vehicle keys to the first party.

Another embodiment of the present disclosure relates to a computer system for managing vehicle keys. The computer system includes a processing circuit comprising one or more processors configured to record personnel information of entities involved in a key exchange transaction, the entities including a first entity and a second entity; receive a key corresponding to a vehicle parked by the first entity; scan a vehicle identification number (VIN) of a vehicle corresponding to the key exchange transaction, the VIN comprising first transaction information; receive, as second transaction information, information relating to a designated compartment of the an organizational container to which vehicle keys corresponding to the vehicle are assigned; display, via a display device, information relating to the designated compartment to the second entity; and store, in one or more data structures, as transaction information, the first transaction information, and the second transaction information. The computer system also includes a camera system configured to: record video footage of the key exchange transaction between involved entity; and store the recorded video footage to the database one or more data structures in association with the transaction information.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a key management system, according to an exemplary embodiment.

FIG. 2 is a perspective view of an organization enclosure with individualized compartments to store keys, according to an exemplary embodiment.

FIG. 3 is a perspective view of the key management system configured to assign keys to a storage compartment within the organization enclosure, according to an exemplary embodiment.

FIG. 4 is an illustration of a method of storing vehicle keys using a key management system, according to an exemplary embodiment.

FIG. 5 is a perspective view of the user interface of the key management system to check in keys, according to an exemplary embodiment.

FIG. 6 is an illustration of a method of removing vehicle keys using a key management, according to an exemplary embodiment.

FIG. 7 is a perspective view of the user interface of the key management system to check out keys, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

According to the exemplary embodiment, the key management system may offer several technical benefits to conventional computerized inventory systems. The key management system addresses points of vulnerability for opportunity theft from an internal and external threat standpoint. As an example, a secure storage location comprising bullet proof materials may hold the keys corresponding to the parked vehicles. A camera system may monitor the storage location with 24-hour surveillance. Multiple layers of security locks and ID verification may secure the storage location. As another example, the key management system may address internal threats of opportunity theft through limiting knowledge of the stored key location. The key management system may only approve an entity authorized to use the system to access stored key location information. The key management system may deny an entity in charge of parking vehicles access to the stored key location information. The camera system may monitor the storage location with 24-hour surveillance as well as record footage of each key exchange transaction for future viewing. The configured camera system, combined with the protocol for sharing partial location information between the two entities, may increase the security of the stored keys against internal and external threats of opportunity theft.

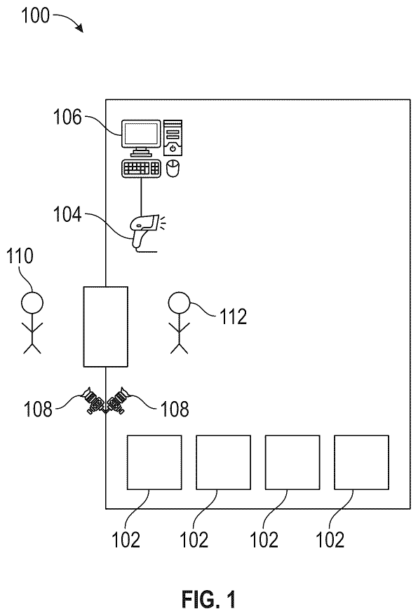

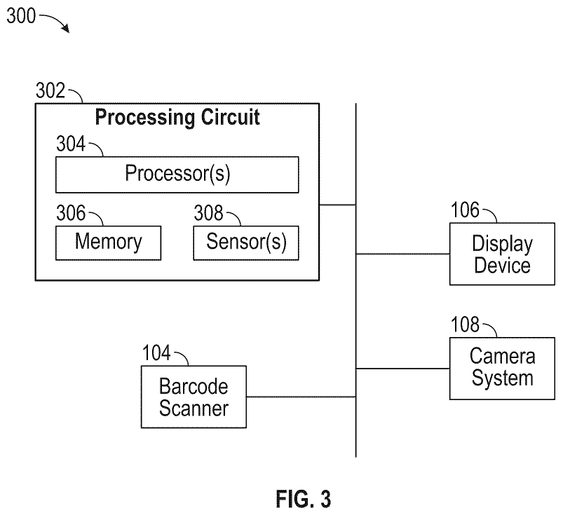

According to an exemplary embodiment as shown in FIG. 1, a key management system 100 is disclosed. In various embodiments, the key management system 100 may be used to secure various vehicle holding sites, but not limited to, vehicle storage lots, dealerships, distribution centers, and the like. The key management system 100 may include one or more organizational containers 102, each including one or more individualized compartments. The one or more organizational containers 102 may include numbered compartments to sort items (e.g., keys). The key management system 100 may include a processing circuit 302 (see FIG. 3) configured to assign a compartment of the organizational container to a key stored to the vehicle holding site. The processing circuit 302 may be configured to scan or otherwise enter vehicle information such as the vehicle identification number (VIN) or other pertinent details about the vehicle via a scanner 104 when assigning the key to a compartment location. The processing circuit 302 may be configured to display information regarding the key exchange transaction via a display device 106. The processing circuit 302 may be coupled with a camera system 108 configured to film transactions between an entity delivering keys and an entity accepting the keys for storage. The camera system 108 may be configured to save video footage of the key exchange transaction to create a transaction record for future reference if a theft were to occur.

In various embodiments, two entities may participate in the key exchange transaction. The two entities may be third-party contractors of a vehicle manufacturer. A first entity 110 may include an institution responsible for parking a vehicle at the vehicle holding site. A second entity 112 may include an institution who provides staff to utilize the key management system 100 such as a security personnel, valet attendants, or similar monitoring staff. In an exemplary embodiment, the key management system 100 may limit access to the location of the keys corresponding to vehicles parked on the offsite vehicle holding lot via an input of an ID badge or employee number. The processing circuit 302 may process the ID badge via the scanner 104. As an example, the key management system 100 may only permit access to the location of the stored keys to an approved ID badge belonging to the second entity 112. As another example, the key management system 100 may deny access to the location of the keys after scanning an ID badge belonging to the first entity 110, as the first entity is not authorized to have knowledge of the location of the stored keys. In an exemplary embodiment, the first entity 110 may have a separate organizational system for parking vehicles on the offsite lot that is not disclosed with the second entity 112 (i.e., the second entity is not authorized to have knowledge of the location of the parked vehicle).

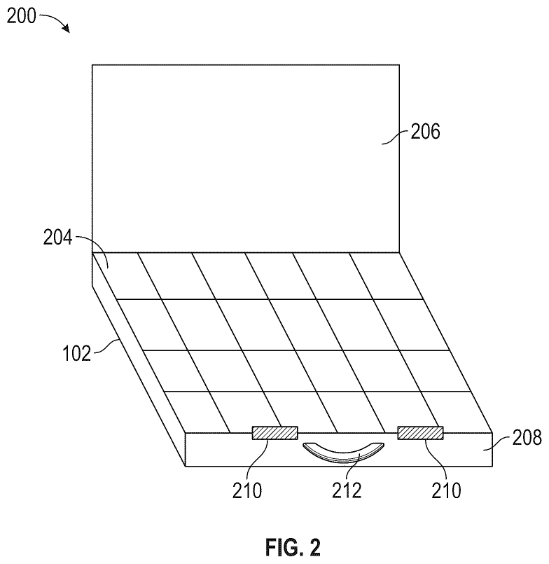

According to the exemplary embodiment depicted in FIG. 2, the key management system 200 may include one or more organizational containers 102. The organizational container may be made of plastic (e.g., polypropylene or polyethylene) or metallic material (e.g., steel, aluminum, or stainless steel). Each organizational container 102 may include one or more individualized compartments 204 intended to separate sets of keys corresponding to parked vehicles on an offsite vehicle holding lot. The individualized compartments 204 may be labeled with a designated compartment naming scheme (e.g., labeling system). As an example, the individualized compartments 204 may be assigned a letter or number corresponding to its placement within the organizational container 202. In some embodiments, the individualized compartments 204 may include a data encoding symbol (e.g., barcode or QR code) to store location information of the compartment. It should be noted that while particular embodiments for the one or more organizational containers 102 are shown and described in the present application, other types of container having any of a variety of different configurations may be utilized to store the keys or other items being tracked by the system (e.g., such containers may be fixed in place within a storage location, may be removable/portable, and may have any number of separate compartments in any desired shape, size, or configuration).

In some embodiments, each organizational container 102 may include a lid 206 to conceal the stored keys and protect the contents of the container from physical damage and environmental conditions. The lid 206 may attach to the organizational container housing 208 via one or more hinges. According to an exemplary embodiment, the organizational container may include a fastening component 210 (e.g., one or more latches, hinges, clips, magnets, or similar components) to secure the lid tightly to the base when stored. In some embodiments, each organizational container may include additional security features such as additional locks such as combination locks, key locks, electronic locks, biometric locks, or magnetic locks that engage with the fastening component 210 to secure the lid tightly. In some embodiments, each organizational container 102 may include an external handle 212 connected to the housing to enhance portability of the stored keys around the storage location.

In an exemplary embodiment shown in FIG. 3, the key management system 300 may include a processing circuit 302 configured to detect and designate keys to the individualized compartments of the organizational container. The processing circuit 302 may include at least one processor 304 and memory 306. The processor(s) 304 may be or include any device, component, element, or hardware designed or configured to perform the various steps recited herein. As an example, the processor(s) 304 may include any number of general purpose single- or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein. In an exemplary embodiment, the processing circuit 302 may include at least one sensor 306 configured to detect (e.g., sense, collect) one or more inputs during a key exchange transaction. As an example, the processing circuit 302 may include one or more optical sensors coupled with a scanner 104 to detect information stored in a data encoding symbol. As another example, the processing circuit 302 may include any number of interface sensors configured to translate operations performed on a touchscreen display or keyboard. As another example, the processing circuit 302 may include one or more motion sensors (e.g., infrared sensors) to activate (e.g., trigger, awaken) the key management system 100 as an entity approaches a location configured with the key management system 100.

In an exemplary embodiment, the processing circuit 302 may be configured to limit access to the stored key location information based on the input of an employee ID badge or number. The processing circuit 302 may be programmed with information of entities authorized with access to the location of the stored keys. The approved entity information may include an employee number. The approved entity information may be entered by an administrator of the institution utilizing the key management system 100. As an example, the processing circuit 302 may permit access to a compartment location of a requested key to an entity with an approved entity number of the institution utilizing the key management system 100 (e.g., the second entity 112). However, the processing circuit 302 may prohibit access to the compartment location of the requested key to an entity belonging to an institution responsible for parking the vehicles on the offsite vehicle holding site (e.g., the first entity 110).

In an exemplary embodiment, the processing circuit 302 may be communicatively coupled to a scanner 104 to retrieve information about a key exchange transaction. As an example, the scanner 104 may comprise a laser scanner or image-based scanner. In various embodiments, the scanner 104 may capture personnel information of entities involved in a key exchange transaction. The entities may include the first entity 110 and the second entity 112. As an example, each entity (e.g., the first entity 110 and the second entity 112) may scan a data encoding symbol located on their respective ID badge via the scanner 104 to record involvement in the transaction. The scanner 104 may convert the data encoding symbol into a digital signal, thereby processing the digital signals into alphanumeric characters corresponding to each respective entity number. The scanner 104 may transmit the processed entity number into a database (e.g., cloud, network).

In some embodiments, the processing circuit 302 may be configured to scan vehicle information such as the vehicle identification number (VIN) via the scanner 104 when initially logging a key. The VIN may comprise first transaction information. As an example, the first entity 110 may deliver the key with a QR code corresponding to the VIN of the parked vehicle. The second entity may then record the VIN using the scanner 104. In some embodiments, the entity identification information and VIN may be manually inputted into the key management system via a keyboard.

In an exemplary embodiment, the processing circuit 302 may be configured to assign vehicle keys to a designated compartment of the organizational container. The compartment location may comprise second transaction information. In various embodiments, the processing circuit 302 may assign the key via scanning a data encoding symbol located in an available compartment. In various embodiments, the processing circuit 302 may randomly assign the key to an available compartment based on a log of compartments in a database.

In an exemplary embodiment, the processing circuit 302 may be configured to display information regarding the key exchange transaction via a display device 106. As an example, the display device 106 may include a computer, tablet, smartphone, or various other displays. The key management system 100 may utilize the display device 106 as a user interface. In some embodiments, the display device 106 may be configured to receive one or more inputs from an authorized user via a touchscreen. In some embodiments, the display device 106 may be configured to receive inputs via a computer mouse and keyboard. In some embodiments, the display device 106 may instruct each entity (e.g., the first entity 110 and the second entity 112) to complete designated tasks throughout the key exchange transaction process. As an example, the key management system 100 may instruct the second party to scan the QR code corresponding to the VIN of the parked vehicle.

In an exemplary embodiment, the processing circuit 302 may be configured to store transaction information. The transaction information may include first transaction information and second transaction information. As an example, the processing circuit 302 may store the transaction in a cloud database. In some embodiments, the processing circuit 302 may continuously store transaction information throughout the duration of the key exchange transaction. In some embodiments, the processing circuit 302 may store the transaction information after the transaction has been complete (e.g., via an input on the display device 106). In some embodiments, the processing circuit 302 may store the transaction information on an additional local drive such as, but not limited to, an internal hard drive (HDD), external hard drive, or USB drive.

In an exemplary embodiment, a camera system 108 may be coupled to the processing circuit 302 to record video footage of the key exchange transaction between involved entities. As an example, the camera system 108 may comprise one or more cameras such as analog cameras, internet protocol (IP) cameras, dome cameras, bullet cameras, pan-tilt-zoom (PTZ) cameras, wireless cameras, or various other cameras. As another example, the camera system 108 may comprise one or more recording devices such as a digital video recorder (DVR), network video recorder (NVR), hybrid recorders, or various other recording devices. In various embodiments, the camera system 108 may comprise one or more microphones to capture audio footage of the key exchange transaction. In some embodiments, the camera system 108 may include a first camera positioned to face the first entity 110 and a second camera positioned to second entity 112 during a transaction. In some embodiments, the camera system 108 may include a singular camera configured to dynamically shift between views of the first entity 110 and the second entity 112 during a transaction. In various embodiments, the camera system 108 may communicate with the processing circuit 302 to transmit the recorded video footage to the database and associate the recorded video footage with the transaction information. In various embodiments, the camera system 108 may communicate with the processing circuit 302 to transcribe the audio footage captured during the key exchange transaction and store the footage with the transaction information.

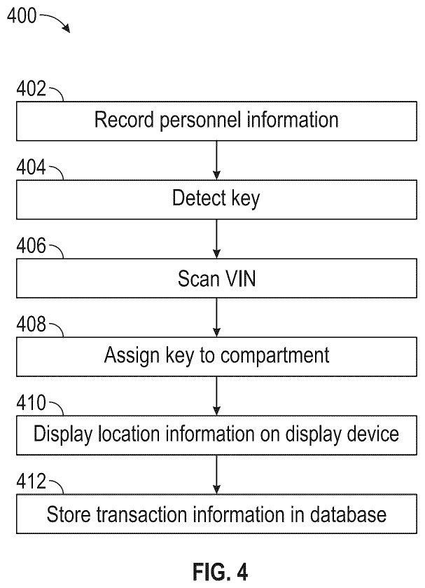

FIG. 4 depicts an illustration of a method 400 for checking in keys using the key management system according to an exemplary embodiment. In act 402, the key management system first records personnel information of each entity involved in a key exchange transaction to initiate the transaction. The key management system may instruct each entity to scan an ID badge before proceeding through a check-in process. The camera system may begin to record the transaction once an ID badge is scanned via the scanner. In act 404, the key management system may detect a key corresponding to a vehicle belonging to the first entity. The first entity may deliver the key through a secure area (e.g., window, slot, lockbox) to the second entity. The system may then record video footage of the key exchange to be stored in the database for future viewing. In act 406, the key management system scans a vehicle identification number (VIN) of a vehicle corresponding to the key exchange transaction. In act 408, the key management system assigns the keys to a designated compartment of the organizational container via a processing circuit. In some embodiments, the second entity may scan a QR code found within an available compartment to associate the key with that compartment via the processing circuit. In some embodiments, the processing circuit may randomly assign the keys to an available compartment. In act 410, the key management system may display, via a display device, information relating to the designated compartment to the second entity. The vehicle keys may then be placed in the designated compartment of an organizational container. In act 412, the key management system stores the transaction information in a database.

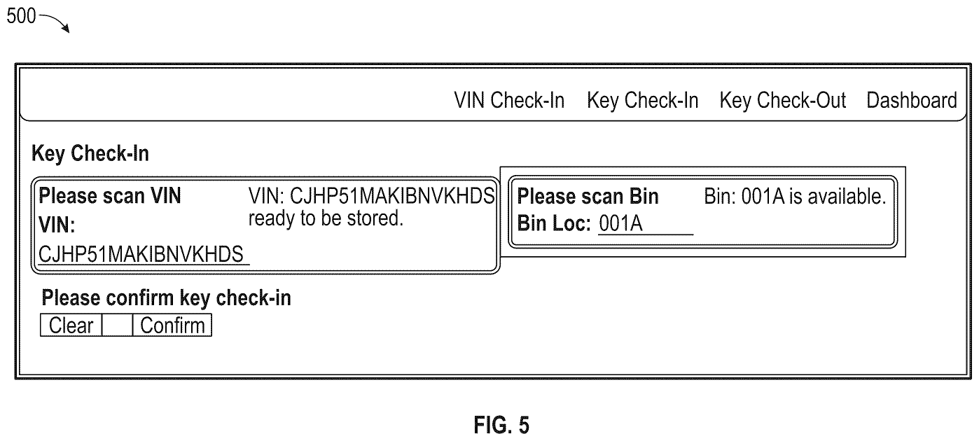

FIG. 5 depicts a view of the key check-in process displayed on the display device 106 according to an exemplary embodiment. The display device may indicate whether the VIN has been scanned or entered. The display device may indicate whether the bin has been scanned or entered. The display device may prompt the second entity to confirm key check-in to complete the transaction. In some embodiments, the display device may notify the second entity if the keys corresponding to the VIN have been stored previously. In some embodiments, the display device may notify the second entity if a bin (e.g., individualized compartment) number is available. In some embodiments, the display device may notify the second entity if a bin (e.g., individualized compartment) number is occupied.

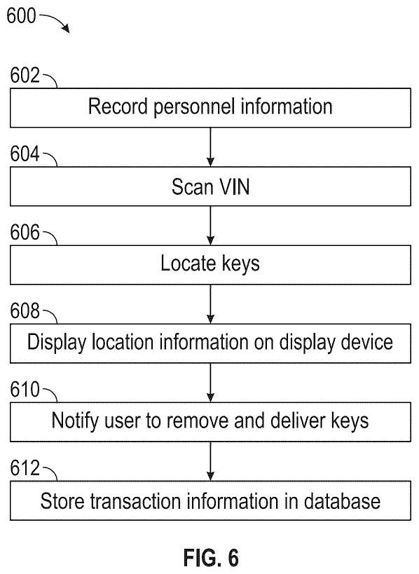

FIG. 6 depicts an illustration of a method 600 for checking out keys using the key management system according to an exemplary embodiment. In act 602, the key management system first records personnel information of entities involved in a key exchange transaction. The key management system may instruct each entity to scan an ID badge before proceeding through the check-in process. The camera system may begin to record the transaction once an ID badge is scanned via the scanner. In act 604, the key management system may scan a vehicle identification number (VIN) of a vehicle corresponding to the key exchange transaction. In act 606, the key management system may locate the stored keys corresponding to the vehicle in a designated compartment of the organizational container in a database. In act 608, the key management system may display, via a display device, information relating to the designated compartment to the second entity. In act 610, the key management system notifies the second entity to remove the vehicle keys from the stored compartment of the organizational container and deliver the vehicle keys to the first entity. In act 612, the key management system stores the transaction information in the database.

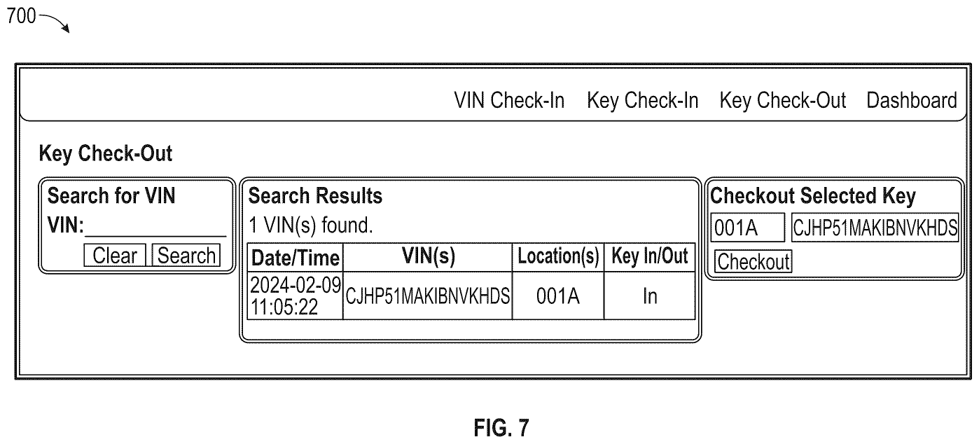

FIG. 7 depicts a view of the key check-out process displayed on the display device according to an exemplary embodiment. The display device may indicate whether the VIN has been scanned or entered. The display device may display the search results for the VIN. The display device may prompt the second entity to confirm key checkout for the stored key to complete the transaction. In some embodiments, the display device may notify the second entity if the keys corresponding to the VIN is not present among the organizational containers. In some embodiments, the display device may notify the second entity about information regarding the initial storage of the key. As an example, the information may include, but is not limited to, date of storage, time of storage, information of the first entity, information of the second entity, duration of transaction.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, As an example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. As an example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A key management system, comprising:
an organizational container comprising individualized compartments for organizing keys;
a processing circuit comprising one or more processors configured to:
record personnel information of entities involved in a key exchange transaction, the entities including a first entity and a second entity;
receive a key corresponding to a vehicle parked by the first entity;
scan a vehicle identification number (VIN) of a vehicle corresponding to the key exchange transaction, the VIN comprising first transaction information;
receive, as second transaction information, information relating to a designated compartment of the organizational container to which vehicle keys corresponding to the vehicle are assigned;
display, via a display device, information relating to the key exchange transaction to the second entity;
store, in one or more data structures, as transaction information, the first transaction information and the second transaction information; and
a camera system coupled to the processing circuit and configured to:
record video footage of the key exchange transaction between involved entity;
store the recorded video footage to the one or more data structures in association with the transaction information.

2. The key management system of claim 1, wherein the processing circuit stores the transaction information in the one or more data structures without any information relating to a parking location of the vehicle parked by the first entity.

3. The key management system of claim 1, wherein recording personnel information of entities involved in the key exchange transaction comprises scanning an ID badge, and wherein the processing circuit limits access to a compartment location of a requested key by requiring input of an approved ID badge or employee number.

4. The key management system of claim 3, wherein the processing circuit prohibits access to information relating to designated compartments of the organizational container, to determine locations of any particular vehicle keys, to the first entity.

5. The key management system of claim 3, wherein the processing circuit permits access to information relating to designated compartments of the organizational container, to retrieve requested vehicle keys, to the second entity.

6. The key management system of claim 1, wherein the processing circuit is communicably coupled with a barcode scanner to scan the VIN of the vehicle.

7. The key management system of claim 1, wherein an RFID tag, barcode, QR code, or similar label is associated with the vehicle keys prior to storage.

8. The key management system of claim 1, wherein the processing circuit assigns the key to a compartment of the organizational container via scanning a QR code on the compartment.

9. The key management system of claim 1, wherein the processing circuit randomly assigns the key to a compartment of the organizational container.

10. The key management system of claim 1, wherein the display device includes a computer, a tablet, or a smart device.

11. A method of storing vehicle keys using a key management system, comprising:
recording personnel information of entities involved in a key exchange transaction, the entities including a first entity and a second entity;
receiving a key corresponding to a vehicle parked by the first entity;
scanning a vehicle identification number (VIN) of a vehicle corresponding to the key exchange transaction, the VIN comprising first transaction information;
receiving, as second transaction information, information relating to a designated compartment of an organizational container to which vehicle keys corresponding to the vehicle are assigned;
displaying, via a display device, information relating to the key exchange transaction to the second entity;
storing, in one or more data structures, as transaction information, the first transaction information and the second transaction information.

12. The method of claim 11, wherein a processing circuit stores the transaction information in the one or more data structures without any information relating to a parking location of the vehicle parked by the first entity.

13. The method of claim 12, wherein the processing circuit limits access to a compartment location of a requested key in the organizational container by requiring input of an approved ID badge or employee number.

14. The method of claim 13, wherein the processing circuit prohibits access to information relating to designated compartments of the organizational container, to determine locations of any particular vehicle keys, to the first entity.

15. The method of claim 13, wherein the processing circuit permits access to information relating to designated compartments of the organizational container, to retrieve requested vehicle keys, to the second entity.

16. The method of claim 12, wherein the processing circuit is communicably coupled with a barcode scanner to scan the VIN of the vehicle.

17. The method of claim 11, wherein an RFID tag, barcode, QR code, or similar label is associated with the vehicle keys prior to storage.

18. The method of claim 12, wherein the processing circuit assigns the key to a compartment of the organizational container via scanning a QR code on the compartment.

19. The method of claim 11, wherein the display device includes a computer, a tablet, or a smart device.

20. A computer system for managing vehicle keys, the computer system comprising:
a processing circuit comprising one or more processors configured to:
record personnel information of entities involved in a key exchange transaction, the entities including a first entity and a second entity;
receive a key corresponding to a vehicle parked by the first entity;
scan a vehicle identification number (VIN) of a vehicle corresponding to the key exchange transaction, the VIN comprising first transaction information;
receive, as second transaction information, information relating to a designated compartment of an organizational container to which vehicle keys corresponding to the vehicle are assigned;
display, via a display device, information relating to the designated compartment to the second entity;
store, in one or more data structures, as transaction information, the first transaction information and the second transaction information; and
a camera system configured to:
record video footage of the key exchange transaction between involved entity;
store the recorded video footage to the one or more data structures in association with the transaction information.
